(19) United States
(12) Patent Application Publication
(10) Pub. No.: US 2011/0188361 A1
(43) Pub. Date: Aug. 4, 2011

(54) RECORDING DEVICE AND METHOD, AND COMPUTER PROGRAM

(75) Inventors: Shoji Fuse, Iruma (JP); Junichi Furukawa, Kawasaki (JP); Hiroshi Nishiwaki, Kawasaki (JP); Yoshio Sasaki, Tokorozawa (JP)

(73) Assignee: Pioneer Corporation, Tokyo (JP)

(21) Appl. No.: 12/679,553

(22) PCT Filed: Sep. 28, 2007
(86) PCT No.: PCT/JP2007/068920

§ 371 Date: May 6, 2010

(51) Int. Cl. G11B 7/125

(52) U.S. Cl. 369/47.51; G9B/7.1

(57) ABSTRACT

A recording apparatus includes: a recording device for recording data onto a recording medium by applying a laser beam whose power can be adjusted; a first controlling device controlling the recording device to record calibration data while adjusting power; a first detecting device detecting calibration data recording quality; a second detecting device detecting push-pull signal amplitude by reading the calibration data; a first calculating device calculating a power by which the recording quality is desired quality, as a first optimum power; a second calculating device calculating a power by which the amplitude of the recorded push-pull signal satisfies a first condition and by which the recording quality satisfies a second condition, as a second optimum power, if the push-pull amplitude fails the first condition; and a second controlling device controlling the recording device to start recording record data by applying the laser beam with the first or second optimum power.

### TECHNICAL FIELD

The present invention relates to a recording apparatus for and method of recording record data onto a recording medium, and a computer program which makes a computer function as the recording apparatus.

### BACKGROUND ART

In a recording apparatus for recording record data onto a recording medium, for example, such as an optical disc, the optimum power of a recording power associated with a laser beam is set by an OPC (Optimum Power Control) process in accordance with the type of the optical disc, the type of the recording apparatus, a recording speed, or the like. In other words, the recording power is calibrated. This can realize an appropriate recording operation in response to variations in property of the information recording surface of the optical disc, or the like. For example, if the optical disc is loaded on the apparatus main body and a writing command is inputted, then, the light intensity of a recording laser beam is changed sequentially and gradually and test-writing data is recorded into an OPC area (Power Calibration Area); namely, a so-called test-writing process is performed. After that, the test-writing data (OPC pattern) recorded in this manner is reproduced, and this reproduction result is judged by a predetermined evaluation criterion to set an optimum power.

Moreover, the OPC (i.e. running OPC) that is simultaneously performed with the actual recording operation also allows the setting of the optimum power associated with the recording laser beam.
Patent document 1: Japanese Patent No. 3159454

### DISCLOSURE OF INVENTION

### Subject to be Solved by the Invention

Recently, a recording medium using a pigment film as a recording layer (e.g. Blu-ray Disc) has been developed. In this recording medium, it is known that the reflectance of the recording layer is increased by recording the record data (by irradiating it with the laser beam). Moreover, in this recording medium, it is found by experiments of the present inventors or the like that the amplitude of a push-pull signal obtained in reproduction greatly varies depending on the power when the record data is recorded. Thus, the amplitude of the push-pull signal obtained in a recording area in which the record data is recorded could be significantly different from the amplitude of the push-pull signal obtained in a recording area in which the record data is not recorded. In this case, if a servo gain in tracking control using the push-pull signal is set in accordance with the amplitude of the push-pull signal obtained in the recording area in which the record data is recorded, then, the tracking control in the recording area in which the record data is not recorded could be unstable. In the same manner, if the servo gain in the tracking control using the push-pull signal is set in accordance with the amplitude of the push-pull signal obtained in the recording area in which the record data is not recorded, then, the tracking control in the recording area in which the record data is recorded could be unstable. In other words, particularly in the reproduction, the tracking control could be unstable due to the significant difference between the amplitude of the push-pull signal obtained in the recording area in which the record data is recorded and the amplitude of the push-pull signal obtained in the recording area in which the record data is not recorded, which is technically problematic.

Moreover, due to the significant variations in the amplitude of the push-pull signal, a leak into a focus error signal could vary (e.g. the leak could increase). Thus, focus control could be also unstable, which is also technically problematic. Moreover, as the worst case, the amplitude of the push-pull signal becomes too large (i.e. the leak becomes too large) by recording the record data, thereby causing an overcurrent to flow in a focus actuator for performing the focus control, and as a result, the actuator could be burnt out or damaged, which is technically problematic.

In view of the aforementioned problems, it is therefore an object of the present invention to provide a recording apparatus and method which can more preferably calculate the optimum power in consideration of the variations of the push-pull signal, as well as a computer program.

### Means for Solving the Subject

The above object of the present invention can be achieved by a recording apparatus provided with: a recording device for recording record data onto a recording medium by applying a laser beam whose power can be adjusted onto the recording medium; a first controlling device for controlling the recording device to record calibration data for calibrating the power of the laser beam onto the recording medium as the record data while adjusting the power in a plurality of ways before the recording of the record data is started; a first detecting device for detecting predetermined recording quality of the calibration data; a second detecting device for detecting an amplitude of a recorded push-pull signal obtained by reading the calibration data; a first calculating device for calculating a power by which the predetermined recording quality detected by the first detecting device is desired quality, as a first optimum power of the laser beam; a second calculating device for calculating a power by which the amplitude of the recorded push-pull signal satisfies a first condition and by which the predetermined recording quality satisfies a second condition, as a second optimum power of the laser beam, if the amplitude of the recorded push-pull signal corresponding to the first optimum power does not satisfy the first condition; and a second controlling device for (i) controlling the recording device to start the recording of the record data by applying the laser beam with the first optimum power if the amplitude of the recorded push-pull signal corresponding to the first optimum power satisfies the first condition and (ii) controlling the recording device to start the recording of the record data by applying the laser beam with the second optimum power if the amplitude of the recorded push-pull signal corresponding to the first optimum power does not satisfy the first condition.

The above object of the present invention can be also achieved by a recording method in a recording apparatus provided with: a recording device for recording record data onto a recording medium by applying a laser beam whose power can be adjusted onto the recording medium, the recording method provided with: a first controlling process of controlling the recording device to record calibration data for calibrating the power of the laser beam onto the recording medium as the record data while adjusting the power in a plurality of ways before the recording of the record data is started; a first detecting process of detecting predetermined recording quality of the calibration data; a second detecting process of detecting an amplitude of a recorded push-pull signal obtained by reading the calibration data; a first calculating process of calculating a power by which the predetermined recording quality detected by the first detecting device is desired quality, as a first optimum power of the laser beam; a second calculating process of calculating a power by which the amplitude of the recorded push-pull signal satisfies a first condition and by which the predetermined recording quality satisfies a second condition, as a second optimum power of the laser beam, if the amplitude of the recorded push-pull signal corresponding to the first optimum power does not satisfy the first condition; and a second controlling process of (i) controlling the recording device to start the recording of the record data by applying the laser beam with the first optimum power if the amplitude of the recorded push-pull signal corresponding to the first optimum power satisfies the first condition and (ii) controlling the recording device to start the recording of the record data by applying the laser beam with the second optimum power if the amplitude of the recorded push-pull signal corresponding to the first optimum power does not satisfy the first condition.

The above object of the present invention can be also achieved by a computer program for recording control and for controlling a computer provided in a recording apparatus provided with: a recording device for recording record data onto a recording medium by applying a laser beam whose power can be adjusted onto the recording medium; a first controlling device for controlling the recording device to record calibration data for calibrating the power of the laser beam onto the recording medium as the record data while adjusting the power in a plurality of ways before the recording of the record data is started; a first detecting device for detecting predetermined recording quality of the calibration data; a second detecting device for detecting an amplitude of a recorded push-pull signal obtained by reading the calibration data; a first calculating device for calculating a power by which the predetermined recording quality detected by the first detecting device is desired quality, as a first optimum power of the laser beam; a second calculating device for calculating a power by which the amplitude of the recorded push-pull signal satisfies a first condition and by which the predetermined recording quality satisfies a second condition, as a second optimum power of the laser beam, if the amplitude of the recorded push-pull signal corresponding to the first optimum power does not satisfy the first condition; and a second controlling device for (i) controlling the recording device to start the recording of the record data by applying the laser beam with the first optimum power if the amplitude of the recorded push-pull signal corresponding to the first optimum power satisfies the first condition and (ii) controlling the recording device to start the recording of the record data by applying the laser beam with the second optimum power if the amplitude of the recorded push-pull signal corresponding to the first optimum power does not satisfy the first condition, the computer program making the computer function as at least one portion of the recording device, the first controlling device, the first detecting device, the second detecting device, the first calculating device, the second calculating device, and the second controlling device.

The operation and other advantages of the present invention will become more apparent from the embodiments explained below.

### BRIEF DESCRIPTION OF DRAWINGS

FIG. 1 is a block diagram conceptually showing the basic structure of an information recording apparatus in an example.

FIG. 2 is a schematic plan view showing the basic structure of an optical disc and a schematic conceptual view showing a recording area structure in the radial direction of the optical disc.

FIG. 3 is a flowchart conceptually showing a flow of an operation example of the recording apparatus in the example.

FIG. 4 is a block diagram conceptually showing a first structure example of a PP amplitude detection circuit.

FIG. 5 is a block diagram conceptually showing a second structure example of the PP amplitude detection circuit.

FIG. 6 is a block diagram conceptually showing a third structure example of the PP amplitude detection circuit.

FIG. 7 are graphs showing an optimum recording laser power, on graphs showing a correlation between a push-pull signal and a recording laser power in a recording area in which an OPC pattern is recorded.

FIG. 8 are graphs conceptually showing aspects of the variations in amplitude of the push-pull signal.

### DESCRIPTION OF REFERENCE CODES

1 recording apparatus
2 disc drive
22 optical pickup
221 LD
222 PD
23 LDD
24 CPU
27 OPC device
28-1 PP amplitude detection device
28-2 modulation-degree detection device
29 recording compensation device
3 host computer

### BEST MODE FOR CARRYING OUT THE INVENTION

Hereinafter, as the best mode for carrying out the present invention, an explanation will be given on embodiments of the recording apparatus and method, and the computer program of the present invention.

### Embodiment of Recording Apparatus

An embodiment of the recording apparatus of the present invention is a recording apparatus provided with: a recording device for recording record data onto a recording medium by applying a laser beam whose power can be adjusted onto the recording medium; a first controlling device for controlling the recording device to record calibration data for calibrating the power of the laser beam onto the recording medium as the record data while adjusting the power in a plurality of ways before the recording of the record data is started; a first detecting device for detecting predetermined recording quality of the calibration data; a second detecting device for detecting an amplitude of a recorded push-pull signal obtained by reading the calibration data; a first calculating device for calculating a power by which the predetermined recording quality detected by the first detecting device is desired quality, as a first optimum power of the laser beam; a second calculating device for calculating a power by which the amplitude of the recorded push-pull signal satisfies a first condition and by which the predetermined recording quality satisfies a second condition, as a second optimum power of the laser beam, if the amplitude of the recorded push-pull signal corresponding to the first optimum power does not satisfy the first condition; and a second controlling device for (i) controlling the recording device to start the recording of the record data by applying the laser beam with the first optimum power if the amplitude of the recorded push-pull signal corresponding to the first optimum power satisfies the first condition and (ii) controlling the recording device to start the recording of the record data by applying the laser beam with the second optimum power if the amplitude of the recorded push-pull signal corresponding to the first optimum power does not satisfy the first condition.

According to the embodiment of the recording apparatus of the present invention, the optimum power of the laser beam is calculated before the recording of the record data, such as video data, audio data, and PC data. In other words, OPC (Optimum Power Control) is performed in which the calibration data is recorded and in which the optimum power is calculated on the basis of the recorded calibration data.

Particularly in the embodiment, when the optimum power is calculated, firstly, the power by which the recording quality (e.g. the degree of modulation, jitter, asymmetry, or the like) obtained by reading the calibration data is the desired quality is calculated as the first optimum power. Then, it is judged whether or not the amplitude of the push-pull signal corresponding to the first optimum power (i.e. which is the push-pull signal obtained by reading the calibration data recorded with the first optimum power, which is the push-pull signal obtained in the recording area in which the calibration data is recorded, and which is referred to as the “recorded push-pull signal”) satisfies the first condition.

If the amplitude of the recorded push-pull signal corresponding to the first optimum power satisfies the first condition, then, the recording of the record data is started by applying the laser beam with the first optimum power.

On the other hand, if the amplitude of the recorded push-pull signal corresponding to the first optimum power does not satisfy the first condition, then, the power by which the amplitude of the recorded push-pull signal corresponding to the first optimum power satisfies the first condition and by which the recording quality, such as the degree of modulation and asymmetry, satisfies the second condition is calculated as the second optimum power, instead of the first optimum power. Then, the recording of the record data is started by applying the laser beam with the second optimum power.

Here, the expression that “the recording quality is the desired quality” indicates, in effect, such a state that the recording quality is optimum quality in the standard of the recording medium or such a state that the recording quality is target quality determined in advance in the standard of the recording medium. On the other hand, the expression that “the recording quality satisfies the second condition” indicates, in effect, such a state that the recording quality is not too bad to preferably read the recorded record data (in other words, such a state that the recording quality is realized to the extent that the recorded record data can be preferably read) and such a state that the recording quality is a good value allowed in the standard of the recording medium. In other words, the state that “the recording quality satisfies the second condition” also includes that “the recording quality is the desired quality”.

Moreover, the expression that “the amplitude of the recorded push-pull signal satisfies the first condition” indicates, in effect, that the amplitude of the recorded push-pull signal is in such a state that an operation of recording the record data (or an operation of reading the recorded record data) can be stably performed.

As described above, according to the embodiment, the optimum power (i.e. which is the first optimum power and the second optimum power and in which the “optimum power” is hereinafter used in a wide meaning including the first optimum power and the second optimum power) is calculated in consideration of not only the recording quality, such as the degree of modulation, jitter, and asymmetry, but also the amplitude of the recorded push-pull signal. Thus, even if the amplitude of the push-pull signal greatly varies, the optimum power is calculated in consideration of the amplitude of the varying push-pull signal. Thus, by using the laser beam with the optimum power calculated in this manner to record the record data, it is possible to appropriately or preferably prevent the occurrence of such a state that the amplitude of the recorded push-pull signal is significantly different from the amplitude of the push-pull signal obtained in the recording area in which the record data is not recorded (i.e. which is the push-pull signal obtained in the recording area in which the calibration data and the record data are unrecorded and which is referred to as the “unrecorded push-pull signal”). By this, even if the amplitude of the push-pull signal greatly varies, the record data can be recorded with the optimum power that allows stable tracking control (moreover, focus control). Therefore, the aforementioned problems do not occur even in the reproduction.

Incidentally, in the aforementioned recording medium using the pigment film as the recording layer, it is found by experiments of the present inventors or the like that there is little or almost no variation of the asymmetry used as an index in the conventional OPC with respect to a change in the power. As described above, if there is little or almost no variation of asymmetry, it is hard or impossible to calculate the optimum power in the conventional OPC. In the embodiment, however, the optimum power is calculated in consideration of each of the amplitude of the recorded push-pull signal and the amplitude of the unrecorded push-pull signal. Thus, even in the recording medium using the pigment film as the recording layer described above, it is possible to preferably perform the OPC, resulting in the preferable calculation of the optimum power.

Incidentally, for the recording medium in which there is little or almost no variation of the asymmetry used as the index in the conventional OPC with respect to the change in the power, the recording quality other than the asymmetry is preferably detected as the recording quality detected by the first detecting device.

Moreover, not only the recording medium using the pigment film as the recording layer but also a recording medium in which the amplitude of the push-pull signal varies to some extent depending on the power in the data recording could be a target for the calculation of the optimum power by the recording apparatus in the embodiment.

Incidentally, in the embodiment, such a power that the variations of the amplitude of the recorded push-pull signal do not prevent the stable recording operation and reproduction operation is preferably calculated as the optimum power. In this sense, it is preferable that the condition that “the amplitude of the recorded push-pull signal satisfies the first condition” in the embodiment is appropriately set in accordance with the property, type, or the like of the recording medium and the property, type, or the like of the recording apparatus.

In one aspect of the recording apparatus of the present invention, the second calculating device calculates a power by which a ratio of the amplitude of the recorded push-pull signal corresponding to the first optimum power with respect to an amplitude of an unrecorded push-pull signal obtained in a recording area in which the record data is unrecorded satisfies a condition according to the first condition, as the second optimum power of the laser beam.

According to this aspect, the second optimum power is calculated on the basis of the ratio between the amplitude of the recorded push-pull signal corresponding to the first optimum power and the amplitude of the unrecorded push-pull signal. Thus, as described above, by using the laser beam with the second optimum power to record the record data, it is possible to appropriately or preferably prevent the occurrence of such a state that the amplitude of the recorded push-pull signal is significantly different from the amplitude of the unrecorded push-pull signal.

In an aspect of the recording apparatus in which the power in which the ratio between the amplitude of the recorded push-pull signal and the amplitude of the unrecorded push-pull signal satisfies the condition according to the first condition is calculated as the second optimum power, as described above, the power by which the ratio satisfies the condition according to the first condition may be a power by which the ratio is within plus/minus (±) 6 dB.

By virtue of such construction, even if the amplitude of the recorded push-pull signal is different from the amplitude of the unrecorded push-pull signal, if the record data is recorded with the second optimum power by which the ratio is within plus/minus (±) 6 dB, then, the tracking control (moreover, focus control) can be stably performed.

In an aspect of the recording apparatus in which the power in which the ratio between the amplitude of the recorded push-pull signal and the amplitude of the unrecorded push-pull signal satisfies the condition according to the first condition is calculated as the second optimum power, as described above, the power by which the ratio satisfies the condition according to the first condition may be a power by which the ratio is within plus/minus (±) 3 dB.

By virtue of such construction, in the sense of allowing for the stability in the tracking control (moreover, focus control), the aforementioned condition that “the ratio is within plus/minus (±) 6 dB” is changed to the strict condition that “the ratio is within plus/minus (±) 3 dB”. Thus, even if the amplitude of the recorded push-pull signal is different from the amplitude of the unrecorded push-pull signal, if the record data is recorded with the second optimum power by which the ratio is within plus/minus (±) 3 dB, then, the tracking control (moreover, focus control) can be performed more stably.

In an aspect of the recording apparatus in which the power in which the ratio between the amplitude of the recorded push-pull signal and the amplitude of the unrecorded push-pull signal satisfies the condition according to the first condition is calculated as the second optimum power, as described above, the power by which the ratio satisfies the condition according to the first condition may be a power by which the amplitude of the recorded push-pull signal is substantially equal to the amplitude of the unrecorded push-pull signal.

By virtue of such construction, it is possible to surely prevent the occurrence of such a state that the amplitude of the recorded push-pull signal is significantly different from the amplitude of the unrecorded push-pull signal. In other words, the recording of the record data rarely causes the variations of the push-pull signal. Thus, the record data can be recorded with the optimum power that allows stable tracking control (moreover, focus control).

In another aspect of the recording apparatus of the present invention, the second detecting device detects the amplitude of the recorded push-pull signal in performing a track jump.

According to this aspect, the amplitude of the recorded push-pull signal can be preferably detected by performing the track jump.

In another aspect of the recording apparatus of the present invention, the second detecting device detects the amplitude of the recorded push-pull signal by estimating the amplitude of the recorded push-pull signal on the basis of a tracking servo gain.

According to this aspect, the amplitude of the recorded push-pull signal can be preferably detected by estimating the amplitude of the recorded push-pull signal on the basis of the tracking servo gain.

In another aspect of the recording apparatus of the present invention, the second detecting device detects the amplitude of the recorded push-pull signal by estimating the amplitude of the recorded push-pull signal on the basis of an amplitude of a wobble signal.

According to this aspect, the amplitude of the recorded push-pull signal can be preferably detected by estimating the amplitude of the recorded push-pull signal on the basis of the amplitude of the wobble signal.

In another aspect of the recording apparatus of the present invention, the recording medium comprises spiral or concentric tracks, and the first controlling device controls the recording device to record the calibration data onto one track with one power and then record the calibration data onto another track, which is different from the one track, with another power, which is different from the one power.

According to this aspect, the calibration data is recorded with the same power in each track. Therefore, even if there are the variations of a recording sensitivity or the like in the circumference of one track, the amplitude of the recorded push-pull signal of the calibration data can be preferably detected without being influenced by the variations. By this, the optimum power can be preferably calculated.

In another aspect of the recording apparatus of the present invention, the recording medium comprises spiral or concentric tracks, and the first controlling device controls the recording device to record the calibration data onto one track with one power and then record the calibration data onto another track, which is located at a position that allows a predetermined space (e.g. a several-track empty space) to exist between the one track and the another track, with another power, which is different from the one power.

According to this aspect, the amplitude of the recorded push-pull signal of the calibration data can be preferably detected without being influenced by a track adjacent to the track that the calibration data is recorded. By this, the optimum power can be preferably calculated.

In another aspect of the recording apparatus of the present invention, it is further provided with an adjusting device for adjusting a strategy of the laser beam such that the recording quality is the desired quality if the recording quality of the record data recorded by applying the laser beam with the first optimum power or the second optimum power is not the desired quality.

According to this aspect, by using the adjusted strategy to record the record data, the record data can be recorded such that not only the push-pull signal but also the other recording qualities (e.g. the degree of modulation, jitter, asymmetry, or the like) are the desired qualities.

### Embodiment of Recording Method

An embodiment of the recording method of the present invention is a recording method in a recording apparatus provided with: a recording device for recording record data onto a recording medium by applying a laser beam whose power can be adjusted onto the recording medium, the recording method provided with: a first controlling process of controlling the recording device to record calibration data for calibrating the power of the laser beam onto the recording medium as the record data while adjusting the power in a plurality of ways before the recording of the record data is started; a first detecting process of detecting predetermined recording quality of the calibration data; a second detecting process of detecting an amplitude of a recorded push-pull signal obtained by reading the calibration data; a first calculating process of calculating a power by which the predetermined recording quality detected by the first detecting device is desired quality, as a first optimum power of the laser beam; a second calculating process of calculating a power by which the amplitude of the recorded push-pull signal satisfies a first condition and by which the predetermined recording quality satisfies a second condition, as a second optimum power of the laser beam, if the amplitude of the recorded push-pull signal corresponding to the first optimum power does not satisfy the first condition; and a second controlling process of (i) controlling the recording device to start the recording of the record data by applying the laser beam with the first optimum power if the amplitude of the recorded push-pull signal corresponding to the first optimum power satisfies the first condition and (ii) controlling the recording device to start the recording of the record data by applying the laser beam with the second optimum power if the amplitude of the recorded push-pull signal corresponding to the first optimum power does not satisfy the first condition.

According to the embodiment of the recording method of the present invention, it is possible to receive the same various effects as those that can be received by the aforementioned embodiment of the recording apparatus of the present invention.

Incidentally, in response to the various aspects in the embodiment of the recording apparatus of the present invention described above, the embodiment of the recording method of the present invention can also adopt various aspects.

### Embodiment of Computer Program

An embodiment of the computer program of the present invention is a computer program for recording control and for controlling a computer provided in a recording apparatus provided with: a recording device for recording record data onto a recording medium by applying a laser beam whose power can be adjusted onto the recording medium; a first controlling device for controlling the recording device to record calibration data for calibrating the power of the laser beam onto the recording medium as the record data while adjusting the power in a plurality of ways before the recording of the record data is started; a first detecting device for detecting predetermined recording quality of the calibration data; a second detecting device for detecting an amplitude of a recorded push-pull signal obtained by reading the calibration data; a first calculating device for calculating a power by which the predetermined recording quality detected by the first detecting device is desired quality, as a first optimum power of the laser beam; a second calculating device for calculating a power by which the amplitude of the recorded push-pull signal satisfies a first condition and by which the predetermined recording quality satisfies a second condition, as a second optimum power of the laser beam, if the amplitude of the recorded push-pull signal corresponding to the first optimum power does not satisfy the first condition; and a second controlling device for (i) controlling the recording device to start the recording of the record data by applying the laser beam with the first optimum power if the amplitude of the recorded push-pull signal corresponding to the first optimum power satisfies the first condition and (ii) controlling the recording device to start the recording of the record data by applying the laser beam with the second optimum power if the amplitude of the recorded push-pull signal corresponding to the first optimum power does not satisfy the first condition (i.e. the aforementioned embodiment of the recording apparatus of the present invention (including its various aspects)), the computer program making the computer function as at least one portion of the recording device, the first controlling device, the first detecting device, the second detecting device, the first calculating device, the second calculating device, and the second controlling device.

According to the computer program of the present invention, the aforementioned embodiment of the recording apparatus of the present invention can be relatively easily realized as a computer provided in the motion picture editing apparatus reads and executes the computer program from a program storage device, such as a ROM, a CD-ROM, a DVD-ROM, and a hard disk, or as it executes the computer program after downloading the program through a communication device.

Incidentally, in response to the various aspects in the embodiment of the recording apparatus of the present invention described above, the embodiment of the computer program of the present invention can also adopt various aspects.

### Embodiment of Computer Program Product

An embodiment of the computer program product of the present invention is a computer program product in a computer-readable medium for tangibly embodying a program of instructions executable by a computer provided in a recording apparatus provided with: a recording device for recording record data onto a recording medium by applying a laser beam whose power can be adjusted onto the recording medium; a first controlling device for controlling the recording device to record calibration data for calibrating the power of the laser beam onto the recording medium as the record data while adjusting the power in a plurality of ways before the recording of the record data is started; a first detecting device for detecting predetermined recording quality of the calibration data; a second detecting device for detecting an amplitude of a recorded push-pull signal obtained by reading the calibration data; a first calculating device for calculating a power by which the predetermined recording quality detected by the first detecting device is desired quality, as a first optimum power of the laser beam; a second calculating device for calculating a power by which the amplitude of the recorded push-pull signal satisfies a first condition and by which the predetermined recording quality satisfies a second condition, as a second optimum power of the laser beam, if the amplitude of the recorded push-pull signal corresponding to the first optimum power does not satisfy the first condition; and a second controlling device for (i) controlling the recording device to start the recording of the record data by applying the laser beam with the first optimum power if the amplitude of the recorded push-pull signal corresponding to the first optimum power satisfies the first condition and (ii) controlling the recording device to start the recording of the record data by applying the laser beam with the second optimum power if the amplitude of the recorded push-pull signal corresponding to the first optimum power does not satisfy the first condition (i.e. the aforementioned embodiment of the recording apparatus of the present invention (including its various aspects)), the computer program product making the computer function as at least one portion of the recording device, the first controlling device, the first detecting device, the second detecting device, the first calculating device, the second calculating device, and the second controlling device.

According to the embodiment of the computer program product of the present invention, the aforementioned embodiment of the recording apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the recording apparatus of the present invention.

Incidentally, in response to the various aspects in the embodiment of the recording apparatus of the present invention described above, the embodiment of the computer program product of the present invention can also adopt various aspects.

The operation and other advantages of the present invention will become more apparent from the example explained below.

As explained above, according to the embodiment of the recording apparatus of the present invention, it is provided with the recording device, the first controlling device, the first detecting device, the second detecting device, the first calculating device, the second calculating device, and the second controlling device. According to the embodiment of the recording method of the present invention, it is provided with the first controlling process, the first detecting process, the second detecting process, the first calculating process, the second calculating process, and the second controlling process. According to the embodiment of the computer program of the present invention, it makes a computer function as the embodiment of the recording apparatus of the present invention. Therefore, it is possible to calculate the optimum power, more preferably, in consideration of the variations of the push-pull signal.

### EXAMPLE

Hereinafter, the example of the present invention will be explained on the basis of the drawings.

### (1-1) Basic Structure

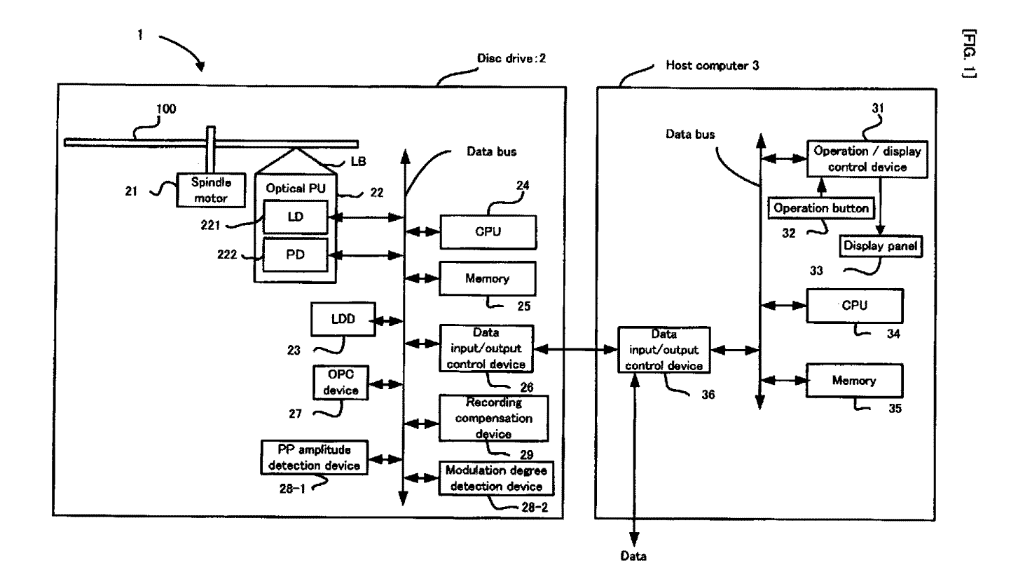

Firstly, with reference to FIG. 1, the basic structure of a recording apparatus 1 in the example will be described. FIG. 1 is a block diagram conceptually showing the basic structure of the recording apparatus in the example.

As shown in FIG. 1, the recording apparatus 1 is provided with a disc drive 2 on which an optical disc 100 is actually loaded and on which data recording and data reproduction are performed; and a host computer 3, such as a personal computer, for controlling the data recording with respect to the disc drive 2.

The disc drive 2 is provided with the optical disc 100, a spindle motor 21, an optical pickup (PU) 22, a LDD (Laser Diode Driver) 23, a CPU 24, a memory 25, a data input/output control device 26, an OPC (Optimum Power Control) device 27, a PP (Push-Pull) amplitude detection device 28-1, a modulation-degree detection device 28-2, and a recording compensation device 29. Moreover, the host computer 3 is provided with an operation/display control device 31, an operation button 32, a display panel 33, a CPU 34, a memory 35, and a data input/output control device 36.

The spindle motor 21 is to rotate and stop the optical disc 100, and it operates when accessing the optical disc 10. More specifically, the spindle motor 21 is constructed to rotate the optical disc 100 at a predetermined speed and stop it, under the spindle servo provided by a servo unit or the like not illustrated.

The optical pickup 22 is provided with a laser diode (LD) 221, which constitutes one specific example of the “recording device” of the present invention with the LDD 23, in order to perform the recording on the optical disc 100. More specifically, in the data recording, the LD 221 provided for the optical pickup 22 irradiates the optical disc 100 with a laser beam LB as recording light, under the control of the LDD 23. By this, the data is recorded onto the optical disc 100.

The optical pickup 22 is also provided with a PD (Photo Detector) 222 for reading the data recorded on the optical disc 100. More specifically, in the data reading, the laser diode 221 provided for the optical pickup 22 irradiates the optical disc 100 with the laser beam LB as reading light, under the control of the LDD 23. The reflected light of the irradiated laser beam LB enters the PD 222. By this, the data recorded on the optical disc 100 is read.

The LDD 23 drives the LD 221 provided for the optical pickup 22, in order to determine an optimum recording laser power by processes of recording and reading an OPC pattern described later, in an OPC process described later. Then, in the data recording, the LDD 23 drives the LD 221 provided for the optical pickup 22 with the optimum recording laser power determined by the OPC process. In the data recording, the optimum recording laser power is modulated in accordance with the data to be recorded.

The CPU 24 is connected to the various constituent devices provided for the disc drive 2 through a data bus, and it controls the entire disc drive 2 by giving instructions to the various constituent devices. Normally, software or firmware for operating the CPU 24 is stored in the memory 25

The memory 25 is used in the general data processing on the disc drive 10 and the OPC process. Moreover, the memory 25 is provided with a ROM area in which a program for enabling the operations as the disc drive 2 to be performed, i.e., firmware, is stored; a RAM area in which the data is temporarily stored; and the like.

The data input/output control device 26 controls the data input/output from the exterior with respect to the disc drive 2. A drive control command, which is issued from the external host computer 3 connected to the disc drive 2 via an interface, such as a SCSI (Small Computer System Interface) and an ATAPI (AT Attachment Packet Interface), is transmitted to the CPU 24 through the data input/output control device 26. Moreover, the data to be recorded is also exchanged with the host computer 3 through the data input/output control device 26.

The OPC device 27 controls the OPC process. Specifically, the OPC device 27 controls the LDD 23 to record the OPC pattern. Moreover, the OPC device 27 calculates the optimum recording laser power on the basis of each of the amplitude of a PP signal detected on the PP amplitude detection device 28-1, which receives the reading result of the recorded OPC pattern from the PD 222, and the degree of modulation detected on the modulation-degree detection device 28-2, which receives the reading result of the recorded OPC pattern from the PD 222.

The PP amplitude detection device 28-1 can detect the amplitude of the push-pull signal. Specifically, the PP amplitude detection device 28-1 can detect the amplitude of the push-pull signal on the basis of the reading result on the PD 222.

The modulation-degree detection device 28-2 can detect the degree of modulation. Specifically, the modulation-degree detection device 28-2 can detect the degree of modulation on the basis of the reading result on the PD 222.

The recording compensation device 29 can adjust a recording strategy for the LDD 23 driving the LD 221.

The operation/display control device 31 performs the reception of the operation instruction and display with respect to the host computer 3. The operation/display control device 31 sends an instruction to perform the “recording”, using the operation bottom 32, to the CPU 34.

The CPU 34 sends a control command to the disc drive 2 through the data input/output control device 36 on the basis of the instruction information from the operation/display control device 31, thereby controlling the entire disc drive 2. In the same manner, the CPU 34 can send a command of requiring the disc drive 2 to send the operational state to the host, to the disc drive 2. By this, it is possible to recognize the operational state of the disc drive 2, such as during recording. Thus, the CPU 34 can output the operational state of the disc drive 2, to the display panel 33, such as a fluorescent tube and a LCD, through the operation/display control device 31.

The memory 35 is an internal memory apparatus used by the host computer 3, and it is provided with, for example, a ROM area in which a firmware program such as BIOS (Basic Input/Output System) is stored; a RAM area in which a parameter required for the operation of an operating system, an application program, or the like is stored; and the like.

### (1-2) Optical Disc

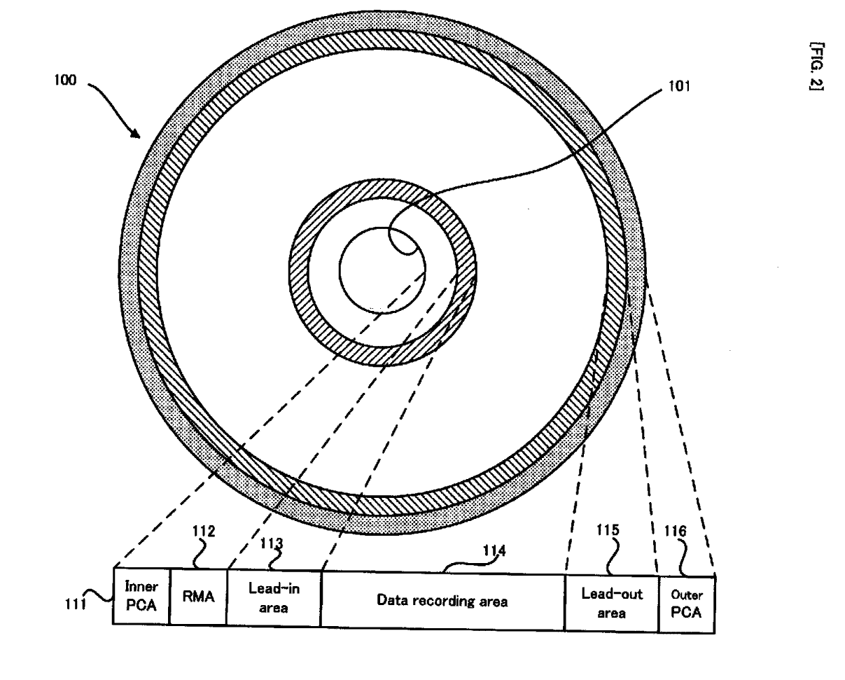

Next, with reference to FIG. 2, an explanation will be given on the basic structure of the optical disc 100 which is the target of the recording operation of the recording apparatus 1 in the example. FIG. 2 is a schematic plan view showing the basic structure of the optical disc 100 and a schematic conceptual view showing a recording area structure in the radial direction of the optical disc 100.

As shown in FIG. 2, the optical disc 100 is provided with a center hole 101 as the center, an inner PCA (Power Calibration Area) 111, a RMA (Recording Management Area) 112, a lead-in area 113, a data recording area 114, a lead-out area 115, and an outer PCA 116, on its recording surface on a disc main body with a diameter of about 12 cm as in a DVD. Moreover, for example, a groove track and a land track are alternately provided, spirally or concentrically, centered on the center hole 101. Moreover, on this track, a data pattern is divided and recorded by a unit of ECC block. The ECC block is an error-correctable data management unit. Moreover, in the example, the optical disc 100 may be a recordable (or write-once) recording medium on which the data pattern can be recorded only once, or a rewritable recording medium on which the data pattern can be recorded a plurality of times.

Moreover, the groove track is oscillated with a constant amplitude and at a constant spatial frequency. In other words, the groove track is wobbled, and the cycle of the wobble is set to a predetermined value. On the land track, a pit referred to as a land pre-pit (LPP) which indicates a pre-format address is formed. By virtue of the two addressing (i.e. the wobble and the land pre-pit), it is possible to perform disc rotation control during the recording and to generate a recording clock, as well as obtaining information required for the recording of the data pattern, such as a recording address. Incidentally, the pre-format address may be recorded in advance by modulating the wobble of the groove track in a predetermined modulation method, such as frequency modulation and phase modulation.

### (1-3) Operation Example

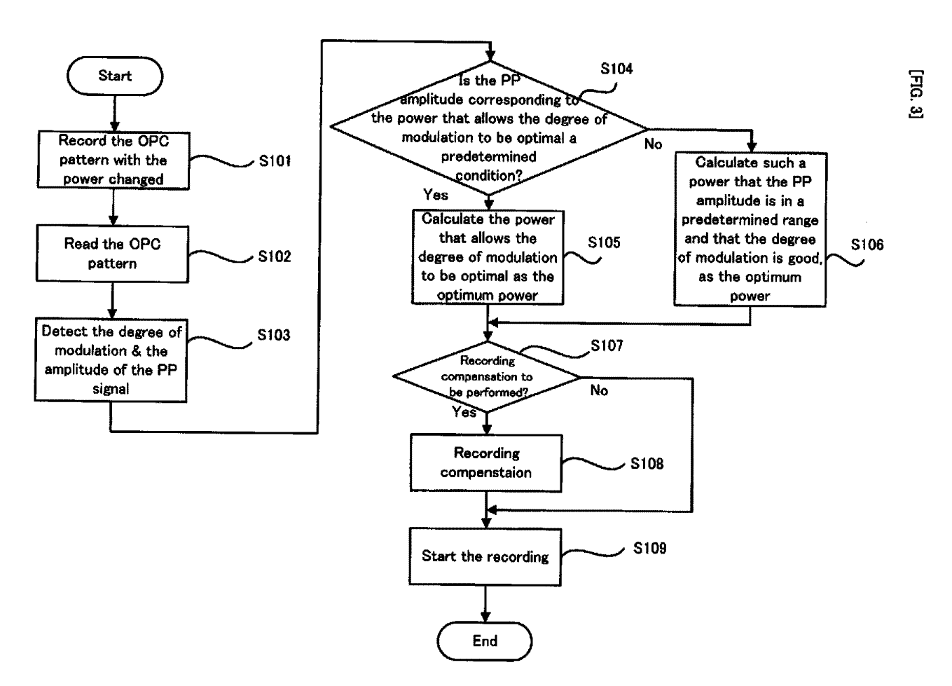

Next, with reference to FIG. 3, an explanation will be given on an operation example of the recording apparatus 1 in the example. FIG. 3 is a flowchart conceptually showing a flow of the operation example of the recording apparatus 1 in the example.

As shown in FIG. 3, before the start of the data recording into the data recording area 114, the OPC process is performed by the control of the OPC device 27 controlled by the CPU 24. Specifically, firstly, under the control of the OPC device 27, which constitutes one specific example of the “first controlling device” of the present invention, the OPC pattern is recorded into the inner PCA 111, with the recording laser power changed sequentially and gradually (step S101). As the OPC pattern, such a recording pattern that short marks corresponding to a 3 T pulse and spaces with the same length as that of the short mark are alternately formed and long marks corresponding to an 11 T pulse and spaces with the same length as that of the long mark are alternately formed is listed as one example.

Then, under the control of the OPC device 27, the OPC pattern recorded in the inner PCA 111 is read by the PD 222 (step S102). The reading of the OPC pattern is repeated by the number of changes of the recording laser power in one OPC process. The reading result by the PD 222 (i.e. the reading result of the OPC pattern) is outputted to each of the PP amplitude detection circuit 28-1 and the modulation-degree detection circuit 28-2.

Then, by the operation of the modulation-degree detection device 28-2, which constitutes one specific example of the “first detecting device” of the present invention, the degree of modulation (i.e. the degree of modulation in the recording area in which the OPC pattern is recorded) is detected from the reading result of the OPC pattern (step S103). In the same manner, by the operation of the PP amplitude detection device 28-1, which constitutes one specific example of the “second detecting device” of the present invention, the amplitude of the push-pull signal obtained from the reading result of the OPC pattern (i.e. the push-pull signal in the recording area in which the OPC pattern is recorded) is detected (step S103). Each of the degree of modulation and the amplitude of the push-pull signal detected is outputted to the OPC device 27. By this, the OPC device 27 can recognize a correlation between the recording laser power and the degree of modulation and a correlation between the recording laser power and the amplitude of the push-pull signal.

Incidentally, in the step S103, it is preferable that the amplitude of the push-pull signal in the recording area in which the data, such as the OPC pattern, is recorded is also detected.

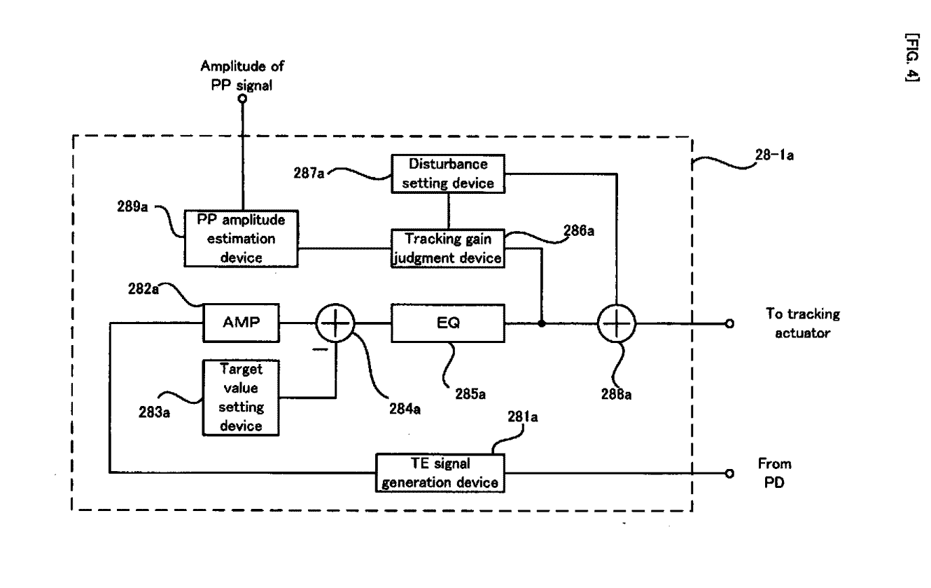

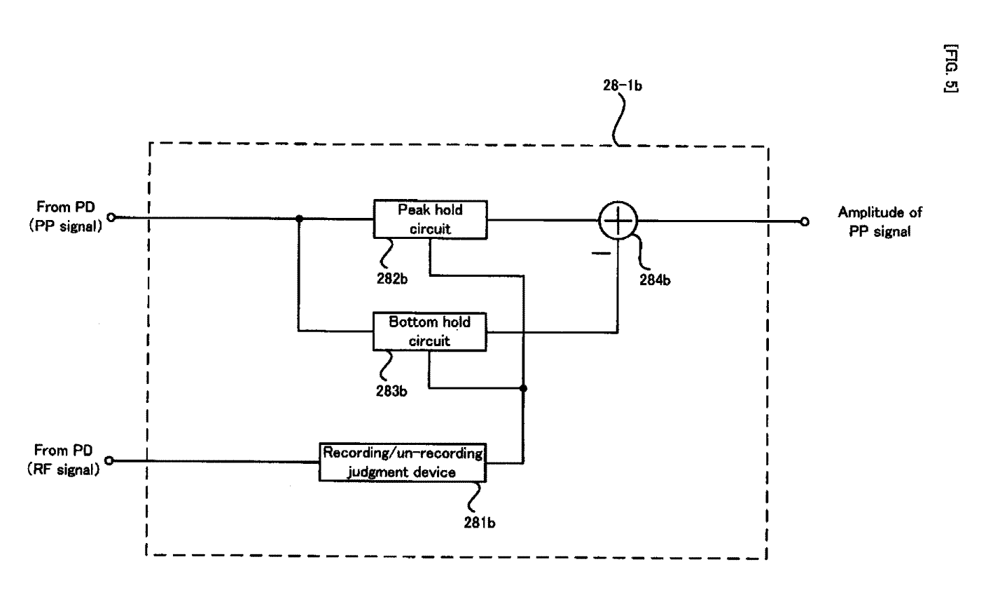

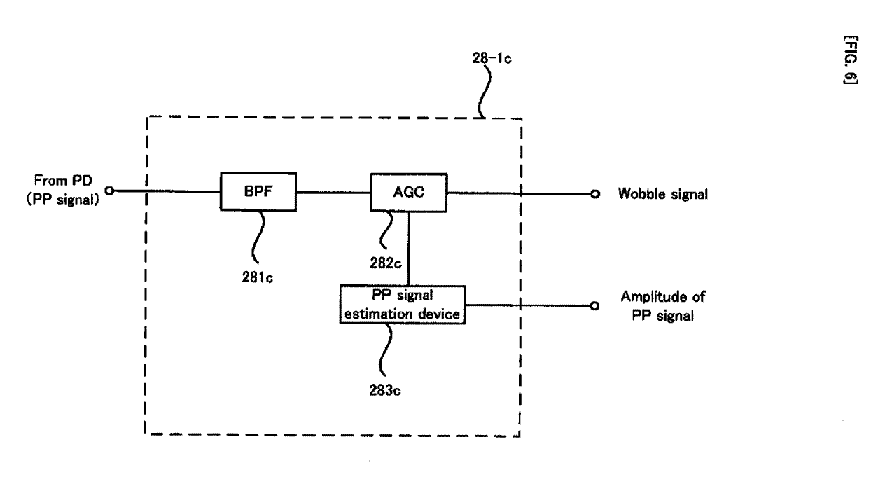

Now, with reference to FIG. 4 to FIG. 6, the specific structure of the PP amplitude detection device 28-1 will be explained. FIG. 4 is a block diagram conceptually showing a first structure example of the PP amplitude detection circuit 28-1. FIG. 5 is a block diagram conceptually showing a second structure example of the PP amplitude detection circuit 28-2. FIG. 6 is a block diagram conceptually showing a third structure example of the PP amplitude detection circuit 28-2.

As shown in FIG. 4, a PP amplitude detection circuit 28-1a in the first structure example is provided with a TE (Tracking Error) signal generation device 281a, an AMP (Amplifier) 282a, a target value setting device 283a, an adder 284a, an EQ (Equalizer) 285a, a tracking gain judgment device 286a, a disturbance setting device 287a, an adder 288a, and a PP amplitude estimation device 289a.

The TE signal generation device 281a generates a TE signal on the basis of the reading result of the PD 222. The generated TE signal is amplified on the AMP 282a. A tracking target value set on the target value setting device 283a is subtracted from the amplified TE signal on the adder 284a, and then, a filtering process is performed on the EQ 285a. As a result, a tracking servo signal is generated. Moreover, in accordance with the gain of the tracking servo signal detected by the tracking gain judgment device 286a, a disturbance signal which is a signal component with a predetermined frequency is added to the tracking servo signal by the operation of the disturbance setting device 287a and the adder 288a. As a result, on the basis of the tracking servo signal to which the disturbance signal is added, a tracking actuator which displaces the optical pickup 22 in a tracking direction is actually driven.

Here, on the PP amplitude detection circuit 28-1a in the first structure example, the amplitude of a push-pull signal is estimated by the operation of the PP amplitude estimation device 289a on the basis of the gain of the tracking servo signal detected on the tracking gain judgment device 286a. The estimated amplitude of the push-pull signal is outputted to the OPC device 27 as the detected amplitude of the push-pull signal.

In other words, the PP amplitude detection circuit 28-1a in the first structure example uses a tracking servo signal generation circuit to detect the amplitude of the push-pull signal.

As shown in FIG. 5, a PP amplitude detection circuit 28-1b in the second structure example is provided with a recording/un-recording judging device 281b, a peak hold circuit 282b, a bottom hold circuit 283b, and an adder 284b.

The reading result of the PD 222 (particularly, a RF signal) is inputted to the recording/un-recording judging device 281b. The recording/un-recording judging device 281b judges whether or not the recording area which is currently read is the recording area in which the data, such as the OPC pattern, is recorded (in other words, whether or not it is the recording area in which the data, such as the OPC pattern, is not recorded), on the basis of the RF signal. The judgment result is outputted to each of the peak hold circuit 282b and the bottom hold circuit 283b.

The reading result of the PD 222 (particularly, the push-pull signal) is inputted to each of the peak hold circuit 282b and the bottom hold circuit 283b. The peak hold circuit 282b and the bottom hold circuit 283b detect the peak value and the bottom value of the push-pull signal, respectively. At this time, using the judgment result on the recording/un-recording judging device 281b, the peak hold circuit 282b and the bottom hold circuit 283b detect the peak value and the bottom value of the push-pull signal in the recording area in which the data, such as the OPC pattern, is recorded, and the peak value and the bottom value of the push-pull signal in the recording area in which the data, such as the OPC pattern, is not recorded, while distinguishing them. Then, on the adder 284b, the bottom value of the push-pull signal detected on the bottom hold circuit 283b is subtracted from the peak value of the push-pull signal detected on the peak hold circuit 282b. As a result, the amplitude of the push-pull signal is obtained. The obtained amplitude of the push-pull signal is outputted to the OPC device 27.

Here, the detection of the amplitude of the push-pull signal using the PP amplitude detection circuit 28-1b in the second structure example is preferably performed when a track jump is performed. Here, in the case where the amplitude of the push-pull signal is obtained by subtracting the bottom value of the push-pull signal detected on the bottom hold circuit 283b from the peak value of the push-pull signal detected on the peak hold circuit 282b, the recording laser power in recording the data, such as the OPC pattern, which is recorded in the recording area before the track jump is preferably equal to the recording laser power in recording the data, such as the OPC pattern, which is recorded in the recording area after the track jump. Alternatively, each of the recording area before the track jump and the recording area after the track jump is preferably the recording area in which the data, such as the OPC pattern, is not recorded.

On the other hand, instead of detecting each of the peak value and the bottom value of the push-pull signal, either one of the peak value and the bottom value of the push-pull signal may be detected, and the detected one of the peak value and the bottom value may be treated as the amplitude of the push-pull signal. In this case, the recording laser power in recording the data, such as the OPC pattern, which is recorded in the recording area before the track jump is not necessarily equal to the recording laser power in recording the data, such as the OPC pattern, which is recorded in the recording area after the track jump.

As shown in FIG. 6, a PP amplitude detection circuit 28-1c in the third structure example is provided with a BPF (Band Pass Filter) 281c, an AGC (Automatic Gain Control) 282c, and a PP amplitude estimation device 283c.

The reading result of the PD 222 (particularly, the push-pull signal) is inputted to the BPF 281c. The BPF 281c outputs only a signal component of the push-pull signal that synchronizes with the frequency of the wobble, to the AGC 282c. On the AGC 282c, the amplitude of the output of the BPF 281c is kept constant by adjusting the gain of the output of the BPF 281c. As a result, the wobble signal is outputted from the AGC 282c.

Here, the PP amplitude estimation device 283c estimates the amplitude of the push-pull signal on the basis of a gain control signal from the AGC 282c. The estimated amplitude of the push-pull signal is outputted to the OPC device 27 as the detected amplitude of the push-pull signal.

In other words, the PP amplitude detection circuit 28-1c in the third structure example detects the amplitude of the push-pull signal by using a wobble signal generation circuit.

In FIG. 3 again, the optimum recording laser power is calculated by the operation of the OPC device 27, which constitutes one specific example of the “first calculating device” and the “second calculating device” of the present invention.

More specifically, firstly, the recording laser power that allows the degree of modulation detected in the step S103 to be optimal is calculated. Then, it is judged whether or not the amplitude of the push-pull signal corresponding to the recording laser power that allows the degree of modulation to be optimal (in other words, the push-pull signal obtained by reading the OPC pattern recorded with the recording laser power that allows the degree of modulation to be optimal) satisfies a predetermined condition (step S104). Here, for example, it is judged whether or not a ratio of the amplitude of the push-pull signal corresponding to the recording laser power that allows the degree of modulation to be optimal with respect to the amplitude of the push-pull signal in the recording area in which the data, such as the OPC pattern, is not recorded satisfies a predetermined condition.

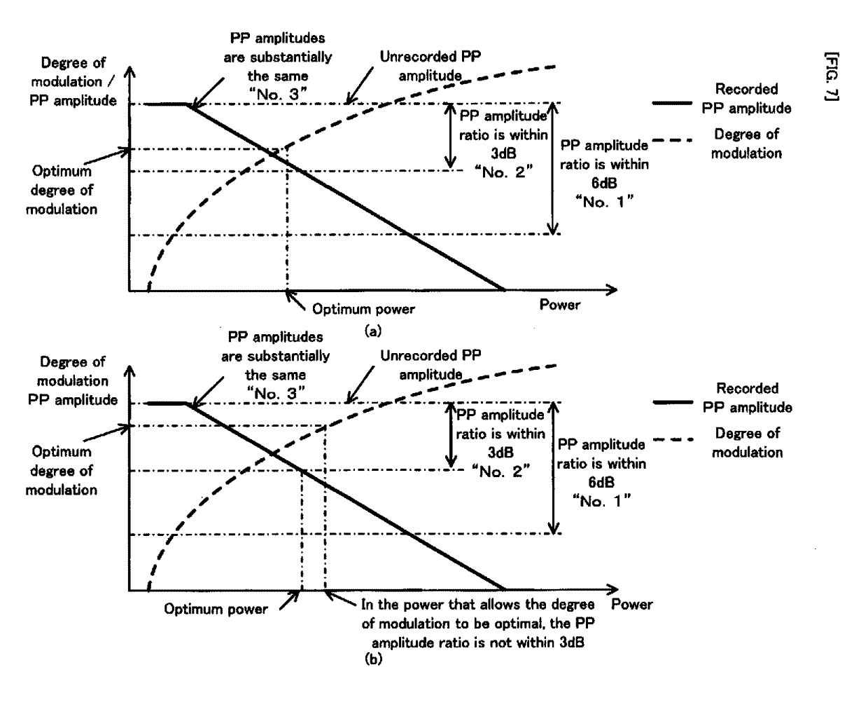

In the example, as the “predetermined condition”, such a condition that “a ratio of the amplitude of the push-pull signal corresponding to the recording laser power that allows the degree of modulation to be optimal with respect to the amplitude of the push-pull signal in the recording area in which the data, such as the OPC pattern, is not recorded is within plus/minus (±) 6 dB” may be used (refer to “No. 1” in FIG. 7 described later).

Preferably, as the “predetermined condition”, such a condition that “a ratio of the amplitude of the push-pull signal corresponding to the recording laser power that allows the degree of modulation to be optimal with respect to the amplitude of the push-pull signal in the recording area in which the data, such as the OPC pattern, is not recorded is within plus/minus (±) 3 dB” may be used (refer to “No. 2” in FIG. 7 described later).

More preferably, as the “predetermined condition”, such a condition that “a ratio of the amplitude of the push-pull signal corresponding to the recording laser power that allows the degree of modulation to be optimal with respect to the amplitude of the push-pull signal in the recording area in which the data, such as the OPC pattern, is not recorded is approximately 1 (i.e. the amplitude of the push-pull signal in the recording area the data, such as the OPC pattern, is not recorded is substantially same as the amplitude of the push-pull signal corresponding to the recording laser power that allows the degree of modulation to be optimal)” may be used (refer to “No. 3” in FIG. 7 described later).

As a result of the judgment in the step S104, if it is judged that the amplitude of the push-pull signal corresponding to the recording laser power that allows the degree of modulation to be optimal satisfies the predetermined condition (the step S104: Yes), then, the recording laser power that allows the degree of modulation to be optimal is calculated as the optimum recording laser power (step S105).

On the other hand, as a result of the judgment in the step S104, if it is judged that the amplitude of the push-pull signal corresponding to the recording laser power that allows the degree of modulation to be optimal does not satisfy the predetermined condition (the step S104: No), then, such a recording laser power that the amplitude of the push-pull signal corresponding to the recording laser power that allows the degree of modulation to be optimal satisfies the predetermined condition and that the degree of modulation is included in an acceptable range allowed in the standard of the optical disc 100 is calculated as the optimum recording laser power (step S106). In particular, of the recording laser power by which the amplitude of the push-pull signal corresponding to the recording laser power that allows the degree of modulation to be optimal satisfies the predetermined condition, such a recording laser power by which the degree of modulation is an optimum value in the acceptable range allowed in the standard of the optical disc 100 is preferably calculated as the optimum recording laser power.

Now, with reference to FIG. 7, the optimum recording laser power calculated by the recording apparatus in the example will be explained in more detail. FIG. 7 are graphs showing the optimum recording laser power, on graphs showing a correlation between the push-pull signal and the recording laser power in the recording area in which the OPC pattern is recorded.

As shown in FIG. 7(a) and FIG. 7(b), the correlation between the recording laser power and the degree of modulation and the correlation between the recording laser power and the amplitude of the push-pull signal (or PP amplitude) are obtained from the amplitude of the push-pull signal and the degree of modulation detected in the step S103 in FIG. 3. Moreover, in the same manner, the amplitude of the push-pull signal in the recording area in which the data, such as the OPC pattern, is not recorded (or unrecorded PP amplitude) is also obtained.

Here, as the “predetermined condition”, it is assumed that such a condition that “a ratio of the amplitude of the push-pull signal corresponding to the recording laser power that allows the degree of modulation to be optimal with respect to the amplitude of the push-pull signal in the recording area in which the data, such as the OPC pattern, is not recorded is within plus/minus (±) 3 dB” is used.

In the example shown in FIG. 7(a), the amplitude of the push-pull signal corresponding to the recording laser power that allows the degree of modulation to be optimal satisfies the condition that “a ratio of the amplitude of the push-pull signal corresponding to the recording laser power that allows the degree of modulation to be optimal with respect to the amplitude of the push-pull signal in the recording area in which the data, such as the OPC pattern, is not recorded is within plus/minus (±) 3 dB”. Thus, in the example shown in FIG. 7(a), the recording laser power that allows the degree of modulation to be optimal is calculated as the optimum recording laser power.

On the other hand, in the example shown in FIG. 7(b), the amplitude of the push-pull signal corresponding to the recording laser power that allows the degree of modulation to be optimal does not satisfy the condition that “a ratio of the amplitude of the push-pull signal corresponding to the recording laser power that allows the degree of modulation to be optimal with respect to the amplitude of the push-pull signal in the recording area in which the data, such as the OPC pattern, is not recorded is within plus/minus (±) 3 dB”. Thus, in the example shown in FIG. 7(b), of the recording laser power that satisfies the condition that “a ratio of the amplitude of the push-pull signal corresponding to the recording laser power that allows the degree of modulation to be optimal with respect to the amplitude of the push-pull signal in the recording area in which the data, such as the OPC pattern, is not recorded is within plus/minus (±) 3 dB”, such a recording laser power that allows the degree of modulation to be optimal (e.g. minimal) is calculated as the optimum recording laser power.

Incidentally, in the aforementioned example, the optimum recording laser power is calculated on the basis of the ratio of the amplitude of the push-pull signal. However, in one optical disc 100, generally, the amplitude of the push-pull signal in the recording area in which the data, such as the OPC pattern, is not recorded does not change. In view of this, the optimum recording laser power may be performed on the basis of the amplitude of the push-pull signal in the recording area in which the OPC pattern is recorded, instead of the ratio of the amplitude of the push-pull signal.

In FIG. 3 again, then, under the control of the recording compensation device 29, which constitutes one specific example of the “adjusting device” of the present invention, it is judged whether or not a recording compensation operation of adjusting the recording strategy is to be performed (step S107). Here, the data is once recorded with the optimum recording laser power calculated in the step S105 or the step S106, and if the recording quality (e.g. the degree of modulation, jitter, asymmetry, or the like) of the recorded data is good, then, it is judged that the recording compensation is not to be performed. On the other hand, if the recording quality of the data recorded with the optimum recording laser power is not good, then, it is judged that the recording compensation is to be performed.

As a result of the judgment in the step S107, if it is judged that the recording compensation operation is to be performed (the step S107: Yes), the recording compensation operation is performed by the operation of the recording compensation operation 29, which constitutes one specific example of the “adjusting device” of the present invention (step S108). Specifically, the recording strategy (particularly, an element other than a peak power) is adjusted such that the recording quality of the data recorded with the optimum recording laser power is good. Incidentally, regarding the details of the recording compensation operation, please refer to Japanese Patent No. 2592086.

Then, under the control of the CPU 24, which constitutes one specific example of the “second controlling device” of the present invention, the recording of the data into the data recording area 114 is started (step S109). In other words, if the amplitude of the push-pull signal corresponding to the recording laser power that allows the degree of modulation to be optimal satisfies the predetermined condition, the data recording is started by applying the laser beam LB with the optimum recording laser power calculated in the step S105 with it modulated in accordance with the recording strategy adjusted in the step S108. On the other hand, if the amplitude of the push-pull signal corresponding to the recording laser power that allows the degree of modulation to be optimal does not satisfy the predetermined condition, the data recording is started by applying the laser beam LB with the optimum recording laser power calculated in the step S106 with it modulated in accordance with the recording strategy adjusted in the step S108.

On the other hand, as a result of the judgment in the step S107, if it is judged that the recording compensation operation is not to be performed (the step S107: No), then, the recording of the data into the data recording area 114 is started without performing the recording compensation operation under the control of the CPU 24 (step S109). In other words, if the amplitude of the push-pull signal corresponding to the recording laser power that allows the degree of modulation to be optimal satisfies the predetermined condition, then, the data recording is started by applying the laser beam LB with the optimum recording laser power calculated in the step S105 with it modulated in accordance with the recording strategy of default. On the other hand, if the amplitude of the push-pull signal corresponding to the recording laser power that allows the degree of modulation to be optimal does not satisfy the predetermined condition, then, the data recording is started by applying the laser beam LB with the optimum recording laser power calculated in the step S106 with it modulated in accordance with the recording strategy of default.

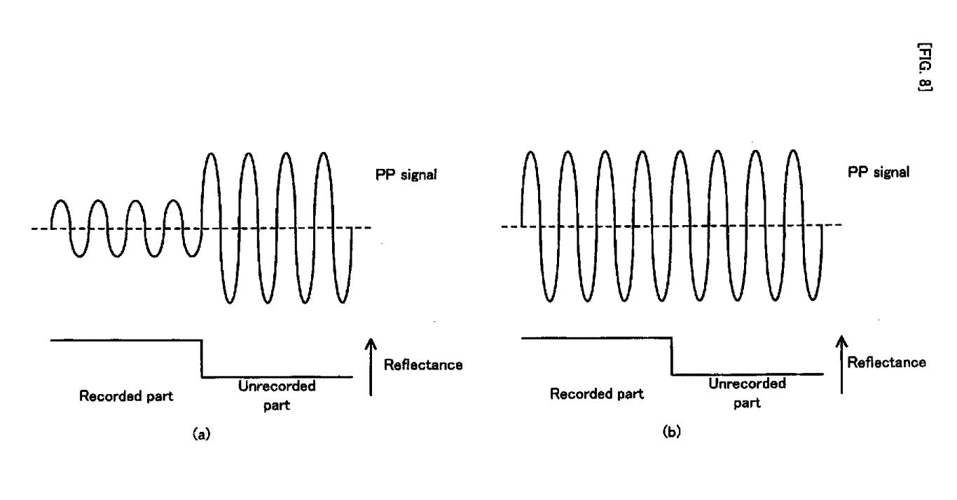

Here, in the optical disc 100 using a pigment film as a recording layer (e.g. Blu-ray Disc), it is found by experiments of the present inventors or the like that the amplitude of the push-pull signal obtained in reproduction greatly varies depending on the recording laser power. Thus, as shown in FIG. 8(a), the amplitude of the push-pull signal in the recording area in which the data is recorded could be significantly different from the amplitude of the push-pull signal obtained in the recording area in which the data is not recorded.

In the example, however, as opposed to the conventional OPC, the recording laser power not only that allows the good recording quality, such as the degree of modulation, jitter, and asymmetry, but also that allows a small difference (or no difference) between the amplitude of the push-pull signal in the recording area in which the data is recorded and the amplitude of the push-pull signal in the recording area in which the data is not recorded is calculated as the optimum recording laser power. Thus, as shown in FIG. 8(b), in the example, this makes a small (or no) difference between the amplitude of the push-pull signal in the recording area in which the data is recorded and the amplitude of the push-pull signal in the recording area in which the data is not recorded. By this, in either of a case where the servo gain in the tracking control is set in accordance with the amplitude of the push-pull signal obtained in the recording area in which the data is not recorded and a case where the servo gain in the tracking control is set in accordance with the amplitude of the push-pull signal obtained in the recording area in which the data is recorded, it is possible to preferably prevent the tracking control from being unstable. Therefore, even if the amplitude of the push-pull signal greatly varies depending on the recording laser power, the data can be recorded with the recording laser power that allows the stable tracking control. Therefore, the aforementioned problems do not occur even in the reproduction.

Moreover, even if the amplitude of the push-pull signal greatly varies depending on the recording laser power, it is possible to preferably prevent such a disadvantage that the leak of the push-pull signal into the focus error signal varies (e.g. the leak becomes large). Therefore, even if the amplitude of the push-pull signal greatly varies depending on the recording laser power, the data can be recorded with the recording laser power that allows the stable focus control. Moreover, it is possible to preferably prevent the actuator which performs the focus control, from being damaged or burnt out.

In addition, in the optical disc 100 using the pigment film as the recording layer described above, it is found by experiments of the present inventors or the like that there is little or almost no variation of the asymmetry used as an index in the conventional OPC with respect to a change in the recording laser power. As described above, if there is little or almost no variation of asymmetry, it is hard or impossible to calculate the optimum recording laser power in the conventional OPC. In the example, however, the optimum recording laser power is calculated in consideration of each of the amplitude of the push-pull signal in the recording area in which the data is recorded and the amplitude of the push-pull signal in the recording area in which the data is not recorded. Thus, even in the optical disc 100 using the pigment film as the recording layer described above, it is possible to preferably perform the OPC, resulting in the preferable calculation of the optimum recording laser power.

Incidentally, the aforementioned example explains the structure that the optimum laser power is calculated on the basis of the degree of modulation and the amplitude of the push-pull signal; however, the optimum laser power may be calculated on the basis of other recording qualities, such as jitter and asymmetry, and the push-pull signal, instead of the degree of modulation. However, for the optical disc 100 in which there is little or almost no variation of the asymmetry used as the index in the conventional OPC with respect to the change in the recording laser power, the optimum recording laser power is preferably calculated on the basis of the recording quality other than the asymmetry and the amplitude of the push-pull signal.

Incidentally, obviously, not only the optical disc 100 using the pigment film as the recording layer but also an optical disc in which the amplitude of the push-pull signal varies to some extent depending on the recording laser power in the data recording could be a target for the calculation of the optimum recording laser power by the recording apparatus 1 in the example.

The present invention is not limited to the aforementioned examples, but various changes may be made, if desired, without departing from the essence or spirit of the invention which can be read from the claims and the entire specification. A recording apparatus and method, and a computer program, all of which involve such changes, are also intended to be within the technical scope of the present invention.

1. A recording apparatus comprising:
a recording device for recording record data onto a recording medium by applying a laser beam whose power can be adjusted onto the recording medium;
a first controlling device for controlling the recording device to record calibration data for calibrating the power of the laser beam onto the recording medium as the record data while adjusting the power in a plurality of ways before the recording of the record data is started;
a first detecting device for detecting predetermined recording quality of the calibration data;
a second detecting device for detecting an amplitude of a recorded push-pull signal obtained by reading the calibration data;
a first calculating device for calculating a power by which the predetermined recording quality detected by the first detecting device is desired quality, as a first optimum power of the laser beam;
a second calculating device for calculating a power by which the amplitude of the recorded push-pull signal satisfies a first condition and by which the predetermined recording quality satisfies a second condition, as a second optimum power of the laser beam, if the amplitude of the recorded push-pull signal corresponding to the first optimum power does not satisfy the first condition; and
a second controlling device for (i) controlling the recording device to start the recording of the record data by applying the laser beam with the first optimum power if the amplitude of the recorded push-pull signal corresponding to the first optimum power satisfies the first condition and (ii) controlling the recording device to start the recording of the record data by applying the laser beam with the second optimum power if the amplitude of the recorded push-pull signal corresponding to the first optimum power does not satisfy the first condition.

2. The recording apparatus according to claim 1, wherein the second calculating device calculates a power by which a ratio of the amplitude of the recorded push-pull signal corresponding to the first optimum power with respect to an amplitude of an unrecorded push-pull signal obtained in a recording area in which the record data is unrecorded satisfies a condition according to the first condition, as the second optimum power of the laser beam.

3. The recording apparatus according to claim 2, wherein the power by which the ratio satisfies the condition according to the first condition is a power by which the ratio is within plus/minus (±) 6 dB.

4. The recording apparatus according to claim 2, wherein the power by which the ratio satisfies the condition according to the first condition is a power by which the ratio is within plus/minus (±) 3 dB.

5. The recording apparatus according to claim 2, wherein the power by which the ratio satisfies the condition according to the first condition is a power by which the amplitude of the recorded push-pull signal is substantially equal to the amplitude of the unrecorded push-pull signal.

6. The recording apparatus according to claim 1, wherein the second detecting device detects the amplitude of the recorded push-pull signal in performing a track jump.

7. The recording apparatus according to claim 1, wherein the second detecting device detects the amplitude of the recorded push-pull signal by estimating the amplitude of the recorded push-pull signal on the basis of a tracking servo gain.

8. The recording apparatus according to claim 1, wherein the second detecting device detects the amplitude of the recorded push-pull signal by estimating the amplitude of the recorded push-pull signal on the basis of an amplitude of a wobble signal.

9. The recording apparatus according to claim 1, wherein
the recording medium comprises spiral or concentric tracks, and
the first controlling device controls the recording device to record the calibration data onto one track with one power and then record the calibration data onto another track, which is different from the one track, with another power, which is different from the one power.

10. The recording apparatus according to claim 1, wherein
the recording medium comprises spiral or concentric tracks, and
the first controlling device controls the recording device to record the calibration data onto one track with one power and then record the calibration data onto another track, which is located at a position that allows a predetermined space to exist between the one track and the another track, with another power, which is different from the one power.

11. The recording apparatus according to claim 1, further comprising an adjusting device for adjusting a strategy of the laser beam such that the recording quality is the desired quality if the recording quality of the record data recorded by applying the laser beam with the first optimum power or the second optimum power is not the desired quality.

12. A recording method in a recording apparatus comprising: a recording device for recording record data onto a recording medium by applying a laser beam whose power can be adjusted onto the recording medium, the recording method comprising:
a first controlling process of controlling the recording device to record calibration data for calibrating the power of the laser beam onto the recording medium as the record data while adjusting the power in a plurality of ways before the recording of the record data is started;
a first detecting process of detecting predetermined recording quality of the calibration data;
a second detecting process of detecting an amplitude of a recorded push-pull signal obtained by reading the calibration data;
a first calculating process of calculating a power by which the predetermined recording quality detected by the first detecting device is desired quality, as a first optimum power of the laser beam;
a second calculating process of calculating a power by which the amplitude of the recorded push-pull signal satisfies a first condition and by which the predetermined recording quality satisfies a second condition, as a second optimum power of the laser beam, if the amplitude of the recorded push-pull signal corresponding to the first optimum power does not satisfy the first condition; and
a second controlling process of (i) controlling the recording device to start the recording of the record data by applying the laser beam with the first optimum power if the amplitude of the recorded push-pull signal corresponding to the first optimum power satisfies the first condition and (ii) controlling the recording device to start the recording of the record data by applying the laser beam with the second optimum power if the amplitude of the recorded push-pull signal corresponding to the first optimum power does not satisfy the first condition.

13. A computer readable recording medium recording thereon a computer program for recording control and for controlling a computer provided in a recording apparatus comprising: a recording device for recording record data onto a recording medium by applying a laser beam whose power can be adjusted onto the recording medium; a first controlling device for controlling the recording device to record calibration data for calibrating the power of the laser beam onto the recording medium as the record data while adjusting the power in a plurality of ways before the recording of the record data is started; a first detecting device for detecting predetermined recording quality of the calibration data; a second detecting device for detecting an amplitude of a recorded push-pull signal obtained by reading the calibration data; a first calculating device for calculating a power by which the predetermined recording quality detected by the first detecting device is desired quality, as a first optimum power of the laser beam; a second calculating device for calculating a power by which the amplitude of the recorded push-pull signal satisfies a first condition and by which the predetermined recording quality satisfies a second condition, as a second optimum power of the laser beam, if the amplitude of the recorded push-pull signal corresponding to the first optimum power does not satisfy the first condition; and a second controlling device for (i) controlling the recording device to start the recording of the record data by applying the laser beam with the first optimum power if the amplitude of the recorded push-pull signal corresponding to the first optimum power satisfies the first condition and (ii) controlling the recording device to start the recording of the record data by applying the laser beam with the second optimum power if the amplitude of the recorded push-pull signal corresponding to the first optimum power does not satisfy the first condition,
the computer program making the computer function as at least one portion of the recording device, the first controlling device, the first detecting device, the second detecting device, the first calculating device, the second calculating device, and the second controlling device.
